(19) United States
(12) Patent Application Publication
(10) Pub. No.: US 2005/0073727 A1
(43) Pub. Date: Apr. 7, 2005

(54) Copy apparatus having a 180/degree rotation copy function and a method thereof

(76) Inventors: Sang-cheol Park, Suwon-si (KR); Yun-su Kim, Seongnam-si (KR)

Correspondence Address: STANZIONE & KIM, LLP, 1740 N STREET, N.W., FIRST FLOOR, WASHINGTON, DC, 20036, US

(21) Appl. No.: 10/834,267

(22) Filed: Apr. 29, 2004

(30) Foreign Application Priority Data
Oct. 6, 2003 (KR) 2003-69127

(51) Int. Cl. G03G 15/041; H04N 1/04

(52) U.S. Cl. 358/494; 358/474

(57) ABSTRACT

A copy apparatus having a 180° rotation copy function and a 180° rotation copy method include an input unit, a display unit, a scanning unit to scan a subject disposed on the script plate to be copied, and converting the scanned script into bitmap data, a storage unit to store the converted bitmap data in a memory location that is assigned for the subject to be copied; and in case of a 180° rotation copy command being inputted from the input unit, a control unit to store the converted bitmap data in a memory address of the memory location in descending order. Accordingly, it is possible to copy a subject to be copied with a 180° rotation.

### CROSS-REFERENCE TO RELATED APPLICATIONS

This application claims the benefit of Korean Patent Application No. 2003-69127 filed Oct. 6, 2003, in the Korean Intellectual Property Office, which is incorporated herein in its entirety by reference.

### BACKGROUND OF THE INVENTION

1. Field of the Invention

The present invention relates generally to a copy apparatus of a flat bed scanning mode and a method of controlling the same, and more particularly, to a copy apparatus of a flat bed scanning mode capable of scanning a subject to be copied and copying the subject with a 180° rotation and a method of controlling the same.

2. Description of the Related Art

Generally, an image forming apparatus, such as a duplicator, a printer, a fax machine, or a multipurpose office appliance having multiple image forming apparatuses therein, commonly has a scanning function reading out data recorded on a script.

Typically, a scanning mode includes a sheet feed scanning mode and a flat bed scanning mode. The sheet feed scanning mode is generally adapted to read out an individual script like a general fax. In the sheet feed scanning mode, a stationary image sensor scans the script being transported, and if an ADF (Automatic Document Feeder) is additionally installed, it is possible to automatically scan a plurality of scripts. On the other hand, the flat bed scanning mode is operated like a general photocopier, in which a movable sensor scans the script secured in position, the script including not only a paper sheet but also a book.

FIG. 1 is a perspective view showing a conventional copy apparatus copying an original document, utilizing the flat bed scanning mode. In the conventional copy apparatus 10 as shown in FIG. 1, a situation shown in FIG. 1 sometimes occurs when a book 20 is laid on a script plate 12 as an original document. More specifically, FIG. 1 shows a conventional copy apparatus copying a document. Referring to FIG. 1, a book 20 is opened as an original document to face the script plate and is bigger than the script plate 12 of the copy apparatus 10. Accordingly, since a user cannot make a copy of the entire documents of the book 20, the user should make a copy for each page. In the mean time, in order for the user to copy each page of the book, the user makes a copy of a certain page of the book and then rotates the book by 180° to make a copy of an adjoining page next to the certain page due to a position of the cover 11 of the copy apparatus so that the adjoining page is properly placed to face the script plate 12. As a result, copies of the book are positioned in an alternate fashion by an interval of an angle of 180°. Therefore, the user has to align the copies in a uniform direction. Because two adjoining pages of the book are copied at an angle of 180°, there is a disadvantage that the user has to rearrange the copies by rotating every other copy by 180° for use. This can be very cumbersome for the user especially if the original document has multiple pages.

### SUMMARY OF THE INVENTION

In order to solve the above and/or other drawbacks and problems associated with the conventional arrangement, it is an aspect of the present invention to provide a copy apparatus having a 180° rotation copy function and a 180° rotation copy method thereof in which, according to a command by a user, image data of a scanned document is stored in a storage unit in a reverse order such that a copy bearing a 180°-rotated image can be obtained.

It is another aspect of the present invention to provide a copy apparatus having a 180° rotation copy function and a 180° rotation copy method, wherein a copying resultant with a 180° rotation is obtained by scanning a subject to be copied according to a user command, storing image data thereof in a storage therein, and re-storing the image data in a descending order.

It is yet another aspect of the present invention to provide a copy apparatus having a 180° rotation copy function and a 180° rotation copy method wherein a copying resultant with a 180° rotation is obtained by determining whether or not image data of a subject to be automatically scanned to be copied has a direction reverse to a prescribed reference direction, and by correcting the direction when the image data direction is reverse to the prescribed reference direction.

Additional aspects and advantages of the invention will be set forth in part in the description which follows and, in part, will be obvious from the description, or may be learned by practice of the invention.

In order to accomplish the above-described and/or other aspects of the present invention, there is provided a copy apparatus of a flat bed scanning mode, the copy apparatus having a script plate, an input unit, a display unit, a scanning unit to scan a subject disposed on the script plate to be copied and to convert the scanned subject into bitmap data, a storage unit to store the converted bitmap data in a memory location that is assigned for the subject to be copied, and a control unit to control the converted bitmap data to be stored in a memory address of the memory location in descending order when a 180° rotation copy command is inputted from the input unit.

According to another aspect of the present invention, the storage unit may include a scanning memory to store the converted bitmap data in a first memory location that is assigned for the subject to be copied, and the control unit allows the converted bitmap data to be stored from a last address of the first memory location in descending order when the 180° rotation copy command is inputted from the input unit.

According to another aspect of the present invention, the copy apparatus may further include a printing unit, and the storage unit may further include a scanning memory to store the converted bitmap data in a first memory location that is assigned for the subject to be copied, and a printing memory to receive the bitmap data stored in the scanning memory and re-storing the bitmap data in a second memory location that is assigned for the subject to be copied, and the control unit allows the bitmap data stored in the first memory location to be re-stored from a last address of the second memory location in descending order when the 180° rotation copy command is inputted from the input unit, and controls the printing unit to sequentially load and print the re-stored bitmap data from a first address of the second memory location.

In order to accomplish the above-described and/or other aspects of the present invention, there is also provided a copy method to which a flat bed scanning mode having a script plate is applied, the copy method including scanning a subject disposed on the script plate to be copied, reading out image data therefrom in the case of a 180° rotation copy command being inputted, converting the read image data into bitmap data; and storing the converted bitmap data in a memory location from a last memory address of the memory location that is assigned for the subject to be copied in descending order.

In order to accomplish the above-described and/or other aspects of the present invention, there is also provided a copy method to which a flat bed scanning mode having a script plate is applied, the copy method including scanning a subject disposed on the script plate, reading out image data therefrom in the case of a 180° rotation copy command being inputted, converting the read image data into bitmap data, storing the converted bitmap data in a memory location that is assigned for the subject to be copied, loading the bitmap data in the memory location from a last memory address of the memory location in descending order, and printing the loaded bitmap data.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a perspective view illustrating a conventional copy apparatus copying a document;

FIG. 2 is a block diagram of a copy apparatus having a 180° rotation function according to an embodiment of the present invention;

FIGS. 3A through 3D are views illustrating an input unit and a display unit of FIG. 2 according to another embodiment of the present invention;

FIG. 4 is a flowchart illustrating respective stages of a 180° rotation copy method according to another embodiment of the present invention;

FIG. 5 is a flowchart illustrating respective stages of a 180° rotation copy method according to another embodiment of the present invention; and

FIG. 6 is a flowchart illustrating respective stages of a 180° rotation copy method according to yet another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 2 is a block diagram of a copy apparatus 100 having a 180° rotation function according to an embodiment of the present invention. With reference to FIG. 2, the copy apparatus 100 according to this embodiment may include an input unit 110, a display unit 120, a scanning unit 130, a storage unit 140, a print unit 150, and a control unit 160.

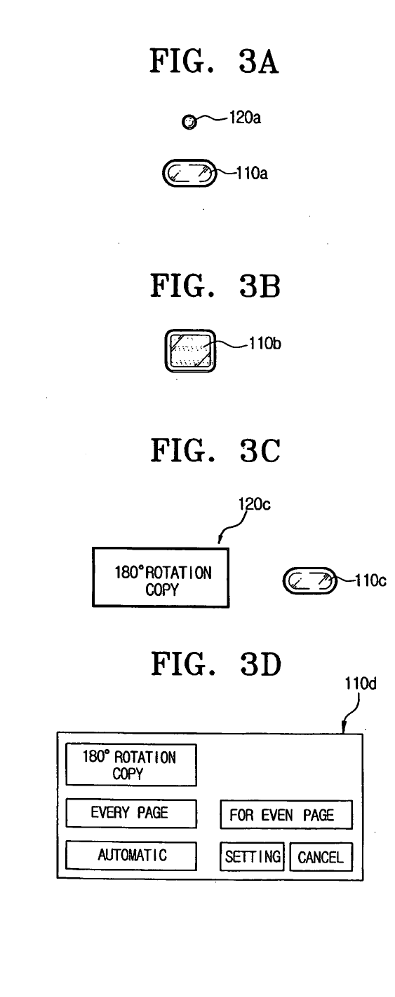

The input unit 110 may include a plurality of function keys to input user commands, such as a 180° rotation copy function key. Upon selecting a certain key through the input unit 110, the control unit 160 can control the copy apparatus 100 in response to the selected key. The display unit 120 can display an operational status of the copy apparatus 100. A display, such as an LCD (Liquid Crystal Display) window or an LED (Light-Emitting Diode), may be used as the display unit 120. As for the input unit 110, a 180° rotation copy toggle key or a 180° rotation copy lamp toggle key as shown in FIGS. 3A to 3D, may be used in the input unit 110. The toggle key, set for a certain function, can be operated such that the certain function is turned on to a certain status when the toggle key is pressed once, and the certain function is released (turned off) when the toggle key is pressed twice. Also, depending on the situation, a touch screen panel (TSP) can be utilized as the input unit 110 and the display unit 120.

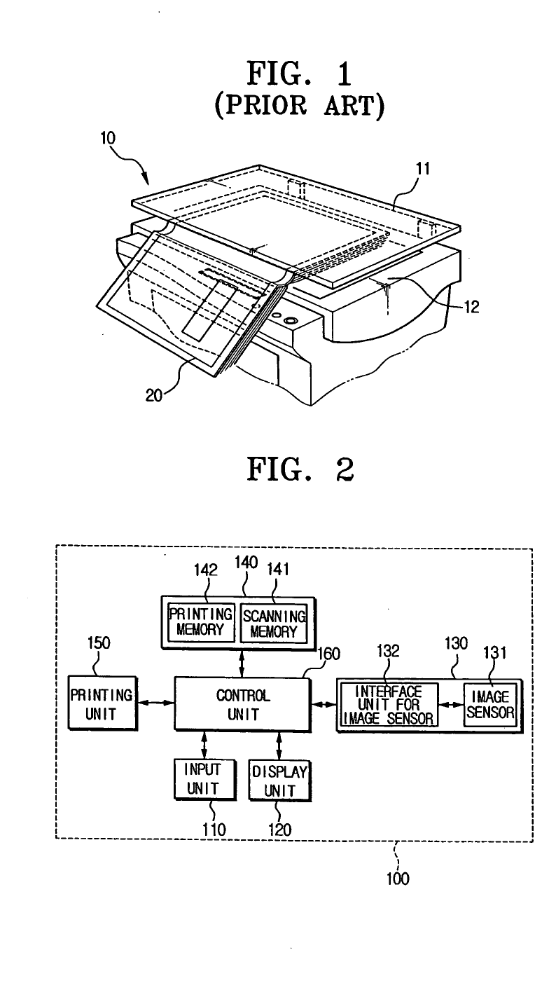

The scanning unit 130 scans an original document placed on a script plate (not shown), for example, a script plate 12 of FIG. 1, to read the image data thereof, and converts the read image data into binary coded bitmap data. The scanning unit 130 may include an image sensor 131 and an interface unit 132 for the image sensor 131.

The image sensor 131 can scan the original document to read the image data thereof. A contact image sensor (CIS) or a charge coupled device (CCD) may be used as the image sensor 131.

The interface unit 132 can convert the image data read from the image sensor 131 into the binary coded bitmap data. Also, the interface unit 132 can transfer the converted bitmap data to a scanning memory 141 under the control of the control unit 160.

The scanning unit 130 may include a read unit (not shown). It may be determined through the read unit as to whether the original document is placed on the script plate in a predetermined reference direction or a reverse direction. If the result of the determination indicates that the read image data is disposed in the reference direction, information about the image sensor 131 can be transferred to the control unit 160. If the read image data is disposed reverse to the reference direction, corresponding information can be transferred to the control unit 160. In this embodiment, an OCR (optical character recognition) system can be utilized as the read unit.

The storage unit 140 can store the converted bitmap data based on the control of the control unit 160 and can also store a control program to control the copy apparatus 100. The storage unit 140 may include the scanning memory 141 and a printing memory 142.

The scanning memory 141 can store the bitmap data converted through the interface unit 132 under the control of the control unit 160. The printing memory 142 receives and stores the bitmap data stored in the scanning memory 141 so that the bitmap data can be transferred to the printing unit 150 to be printed, under the control of the control unit 160.

Typically, the scanning memory 141 and the printing memory 142 may utilize a volatile memory element such as a DRAM. The storage unit 140 may include a non-volatile memory (not shown) which stores various control programs necessary to perform other general operations of the copy apparatus 100.

The printing unit 150 can be operated when the copy apparatus 100 performs a print operation under the control of the control unit 160, and can carry out the print operation on the bitmap data loaded from the printing memory 142 based on a command signal for the print operation.

When the copy apparatus 100 is powered-on, the control unit 160 can control general operations of the copy apparatus 100 according to the control program stored in the non-volatile memory (not shown).

Additionally, the control unit 160 can control the interior of the copy apparatus 100 in response to the user's command inputted through the input unit 110. If a copy command is inputted through the input unit 110, the control unit 160 can also control the scanning unit 130 so that the original document can be scanned and the scanned image data can be converted into the bitmap data through the interface unit 132. Also, when a command to set a 180° rotation copy function is inputted via the input unit 110, the control unit 160 can store the setting information thereof in a predetermined memory location of the storage unit 140, and determines whether or not the 180° rotation copy function has been set in the copy apparatus 100 based on the setting information from the predetermined memory location. As the result of the determination, the control unit 160 can allow the bitmap data to be stored in the scanning memory 141 in sequence or in reverse. Here, the phrase ‘the bitmap data is stored in sequence’ means that the scanned and binary coded bitmap data is stored in ascending order from the first memory address of the memory location assigned for the subject to be copied. The phrase ‘the bitmap data is stored in reverse’ means that the scanned and binary coded bitmap data is stored in descending order from the last memory address of the memory location assigned for the subject to be copied.

It is noted to that the present invention discloses the bitmap data as the converted data for illustrative purposes only, and is not to be limited to only the bitmap data, but may use any other type of image data that provides the intended aspects and/or features of the invention as disclosed. Also, that the bitmap data is “stored in reverse” means that a second image corresponding to second bitmap data is reversed with respect to the first image corresponding to the first bitmap data. When the first and second images are printed, the second printed image is rotated with respect to the first printed image by a predetermined angle, for example, 180°.

According to the result of the setting determination, the control unit 160 can allow the bitmap data from the scanning memory 141 to be re-stored in reverse or in sequence in the printing memory 142. Here, the phrase ‘the bitmap data is re-stored in sequence’ means that the bitmap data in the first memory address of the scanning memory 141 is transferred and re-stored to the first memory address of the printing memory 142, and thereafter re-stored in the corresponding memory addresses of the printing memory 142 in ascending order. The term ‘the bitmap data is stored in reverse’ means that the bitmap data in the first memory address of the scanning memory 141 is transferred and re-stored to the last memory address of the printing memory 142, and thereafter re-stored in the corresponding memory addresses of the printing memory 142 in descending order. Therefore, the bitmap data is stored in reverse when the scanned image corresponding to the bitmap data needs to be rotated by 180°.

If the control unit 160 receives the same direction arrangement information through the read-out unit (not shown), the control unit 160 can control the storage unit 140 and the printing unit 150 according to the general procedures. On the other hand, if the control unit 160 receives the reverse direction arrangement information through the read-out unit, the control unit 160 can control the storage unit 140 and the printing unit 150 according to the same procedures as those in the case where the command to set a 180° rotation copy function is inputted through the input unit 110.

FIGS. 3A to 3F are views showing the input unit 110 and the display unit 120 of the copy apparatus of FIG. 2 according to another embodiment of the present invention.

First, in FIG. 3A, a 180° rotation copy toggle key 110a can be used as the input unit 110, and a light-emitting lamp 120a can be used as the display unit 120. In accordance with this embodiment, when the user presses the 180° rotation copy toggle key 110a to copy a subject to be copied with a 180° rotation, the light-emitting lamp 120a turns on. Thereafter, when the user inputs a copy command for the subject to be copied, the subject to be copied can be copied with a 180° rotation.

In FIG. 3B, the 180° rotation copy lamp toggle key 110b is used as the input unit 110 and the display unit 120. If the 180° rotation copy lamp toggle key 110b is pressed once, the 180° rotation copy function can be set, and at the same time an LED (not shown) incorporated in the 180° rotation copy lamp toggle key 110b turns on. If the 180° rotation copy lamp toggle key 110b is pressed once again, the 180° rotation copy function can be released and at the same time the LED in the 180° rotation copy lamp toggle key 110b is not supplied with the power voltage, thereby turning off the LED.

In FIG. 3C, a 180° rotation copy toggle key 110c is used as the input unit 110, and an LCD window 120c is used as the display unit 120. If the 180° rotation copy toggle key 110c is pressed once, a message of ‘the 180° rotation copy’ is indicated in the LCD window 120c as shown in FIG. 3C, thereby indicating that the 180° rotation copy function has been set, and if the 180° rotation copy toggle key 110c is pressed once again, a message of ‘the 180° rotation copy release’ is indicated in the LCD window 120c, thereby indicating that the setting for 180° rotation copy function is released.

In FIG. 3D, a touch screen panel can be used as the input unit 110 and the display unit 120. This embodiment thereof is as follows: if the user touches the button (not shown) of ‘copy function list’ via the touch screen panel 110d, a sub-menu window can be displayed to allow the user to select additional functions such as ‘the 180° rotation copy’, ‘segmentation copy’, ‘remove border’ ‘copy density’, or ‘taking a margin’. When the user sets the function of ‘the 180° rotation copy’ via the sub-menu window, the sub-menu window 110d, as shown in the FIG. 3D, can be displayed. This embodiment can include touch buttons that can set at least one of ‘every page’, ‘for even page’, ‘automatic’, ‘setting’, and ‘cancel’. In a case where the function of ‘every page’ is set, thereafter, all of the subjects to be copied can be copied with a 180° rotation, and if the function of ‘for even page’ is set, the control unit 160 can count the number of the copied pages, allowing the 180° rotation copy function on the subject to be copied corresponding to an even number to be set. On the other hand, in a case of the ‘automatic’ button being set, even if the 180° rotation copy function has not been set through the input unit 110, it is automatically determined whether or not the subject to be copied is disposed in a direction reverse to the reference direction. If the subject is disposed in the reverse direction, the 180° rotation copy function is applied.

In the function of the 180° rotation copy, the even numbered page image is reversed with respect to the odd numbered page image. It is also noted that the present invention discloses the even numbered page image and the odd numbered page image for illustrative purposes only, and is not to be limited to only the even and odd numbered page image, but may use any numbered page image or sequence that provides the intended aspects and/or features of the invention as disclosed.

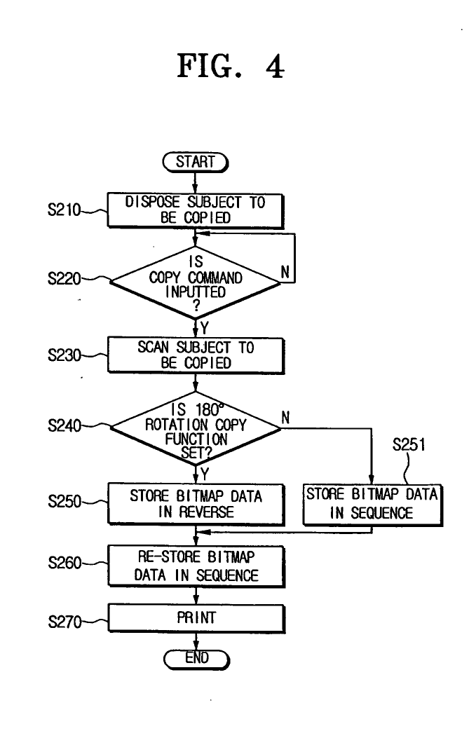

FIG. 4 is a flowchart to explain a 180° rotation copy method according to another embodiment of the present invention. Hereinafter, this embodiment of the 180° rotation copy method will be described with reference to FIG. 4.

First of all, the user displaces the subject to be copied on the script plate (S210) and inputs a copy command (S220). Then, the control unit 160 can control the scanning unit 130 so that the subject to be copied may be scanned to read-out image data therefrom, and the image data may be converted into bitmap data (S230). At this time, the control unit 160 may determine whether or not the 180° rotation copy function has been set through the input unit 110 (S240).

As the result of the determination, in a case of the 180° rotation copy having been set, the control unit 160 may allow the converted bitmap data to be stored in the scanning memory 141 on a basis of a prescribed storage unit in descending order (S250). As the result of the determination, in a case of the 180° rotation copy having been not set, the control unit 160 may allow the converted bitmap data to be sequentially re-stored in the scanning memory 141 on a basis of the prescribed storage unit (S251).

The control unit 160 can read out the bitmap data stored in the scanning memory 141, transfer the read-out bitmap data to corresponding memory addresses of the printing memory 142 in sequence, and have the transferred bitmap data re-stored therein (S260). Therefore, in a case of the 180° rotation copy having been set, the bitmap data can be re-stored with a 180° rotation relative to the image of the subject to be copied that is actually disposed. And, in a case of the 180° rotation copy having been not set, the bitmap data can be re-stored without any rotation relative to the image of the subject to be copied that is actually disposed. If the re-storage of the bitmap data in the printing memory 142 is completed, the control unit 160 can load the re-stored bitmap data and allow the loaded bitmap data to be printed via the printing unit 150 (S370).

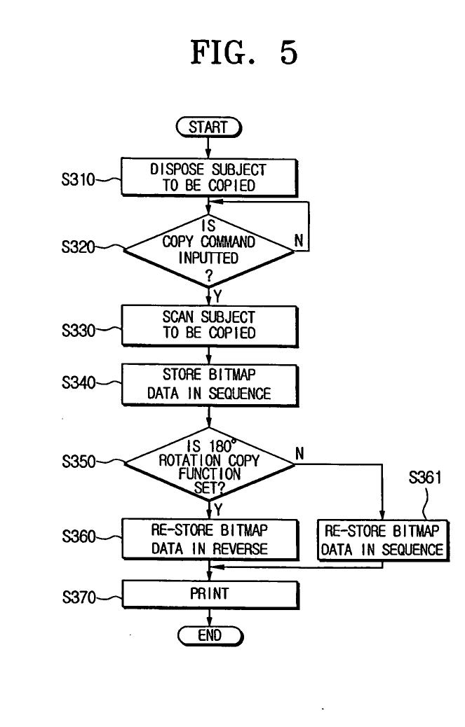

FIG. 5 is a flowchart to explain a 180° rotation copy method according to another embodiment of the present invention. Hereinafter, this embodiment of a 180° rotation copy method according to the present invention will be described with reference to FIG. 5, but the explanation on operations 310, 320, and 330 that overlap with operations 210, 220, and 230 described in FIG. 4 will be omitted.

The bitmap data converted in the step 330 can be sequentially stored in the scanning memory 141. At this time, the control unit 160 can determine whether or not the 180° rotation copy function has been set (S350). As a result of the determination, in a case of the 180° rotation copy function having been set, the control unit 160 can allow the stored bitmap data to be transferred to the printing memory 142 from the scanning memory 141 on a basis of a given storage unit in descending order and to be re-stored therein (S360). On the other hand, as a result of the determination, in a case of the 180° rotation copy function having not been set, the control unit 160 can allow the stored bitmap data to be sequentially transferred to the printing memory 142 from the scanning memory 141 and to be re-stored therein (S361). Then, the control unit 160 can allow the image data re-stored in the printing memory 142 to be printed on printing sheet through the printing unit 150 (S370).

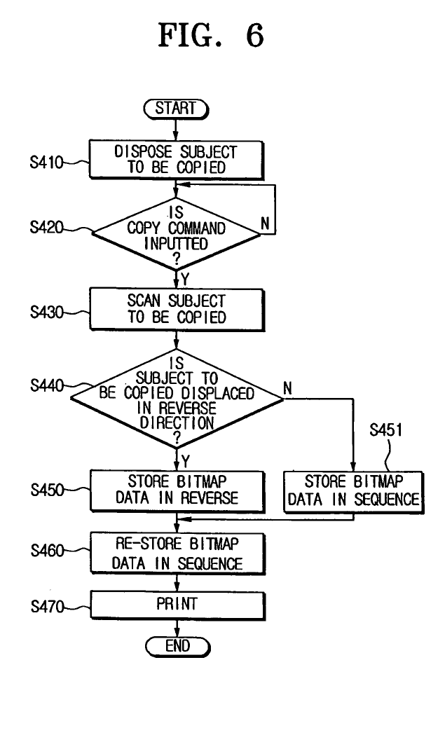

FIG. 6 is a flowchart illustrating a 180° rotation copy method according to yet another embodiment of the present invention. Hereinafter, this embodiment of a 180° rotation copy method according to the present invention will be described with reference to FIG. 6, but a description of operations 410, 420, 430, 460, and 470 that overlap with operations 210, 220, 230, 260, and 270 described in FIG. 4 will be omitted.

In this embodiment, in a case where the ‘automatic’ button is selected in the input unit 110 shown in FIG. 3D, in operation 430, it is determined whether or not the image data read out has the same direction as a preset reference direction (S440). As a result of the determination, if the image data is disposed in the same direction, the control unit 160 can allow the converted bitmap data to be sequentially stored in the scanning memory 141 (S451). As a result of the determination, if the image data is disposed in the reverse direction, the control unit 160 allow the converted bitmap data to be stored in the scanning memory 141 in descending order (S450).

As described in the above, in accordance with the copy apparatus to which the present method is applied, it is possible to copy the image of a subject to be copied with a 180° rotation. Accordingly, when a user attempts to copy a book using the copy apparatus having even a small script plate, it is possible to prevent one page per two pages from being copied with a 180° rotation. Consequently, when a user attempts to copy a number of subjects to be copied, it is possible to reduce the time and efforts in classifying and rearranging the copying resultant that is rotated by 180°.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A copy apparatus of a flat bed scanning mode having a script plate, comprising:
an input unit through which a 180° rotation copy command is generated;
a display unit;
a scanning unit to scan a subject disposed on the script plate to be copied, and to convert the scanned subject into bitmap data;
a storage unit to store the converted bitmap data in a memory location that is assigned for the subject to be copied; and
a control unitto receive an input of the 180° rotation copy command from the input unit, and to store the converted bitmap data in a memory address of the memory location in a descending order.

2. The copy apparatus of claim 1, wherein the storage unit comprises a scanning memory to store the converted bitmap data in a first memory location that is assigned for the subject to be copied, and the control unitstores the converted bitmap data in the first memory from a last address of the first memory location in descending order when the 180° rotation copy command is inputted through the input unit.

3. The copy apparatus of claim 2, further comprising:
a printing unit,
wherein the control unit controls the printing unit so as to load and print the bitmap data that is stored in descending order when the 180° rotation copy command is inputted through the input unit.

4. The copy apparatus of claim 1, further comprising:
a printing unit;
a scanning memory in the storage unit to store the converted bitmap data in a first memory location that is assigned for the subject to be copied; and
a printing memory in the storage unit to receive the bitmap data stored in the scanning memory and to re-store the bitmap data in a second memory location that is assigned for the subject to be copied.

5. The copy apparatus of claim 4, wherein the control unit re-stores the bitmap data stored in the first memory location in the second memory location from a last address of the second memory location in the descending order when the 180° rotation copy command is inputted through the input unit, and controls the printing unit so as to sequentially load and print the re-stored bitmap data from a first address of the second memory location.

6. The copy apparatus of claim 1, wherein the input unit includes a key to set a 180° rotation copy function, the display unit includes a light-emitting lamp to indicate a 180° rotation copy function, and the control unit controls the light-emitting lamp to emit a light signal when the 180° rotation copy function is set through the setting key.

7. The copy apparatus claim 1, wherein the input unit includes a key to set a 180° rotation copy function; the display unit includes an LCD window; and the control unit controls a message of a 180° rotation copy to be indicated on the LED window when the 180° rotation copy function is set through the setting key.

8. A copy method of performing a copy operation in a copy apparatus having a flat bed scanning mode and a script plate, the method comprising:
receiving an input of a 180° rotation copy command;
scanning a subject disposed on the script plate to be copied, and reading out image data therefrom;
converting the read image data into bitmap data; and
storing the converted bitmap data in a memory location from a last memory address of the memory location that is assigned for the subject to be copied in a descending order.

9. The copy method of claim 8, further comprising:
sequentially loading and printing the stored bitmap data from a first memory address of the memory location.

10. A copy method of performing a copy operation in a copy apparatus having a flat bed scanning mode and a script plate, the method comprising:
receiving an input of a 180° rotation copy command;
scanning a subject disposed on the script plate to be copied, and reading out image data therefrom;
converting the read image data into bitmap data; and
storing the converted bitmap data in a memory location that is assigned for the subject to be copied, loading the bitmap data from a last memory address of the memory location in a descending order, and printing the loaded bitmap data.

11. The copy method of claim 10, wherein the printing operation comprises:
sequentially storing the converted bitmap data in the memory location from a first memory address of the memory location; and
loading the stored bitmap data from the last memory address of the memory location in the descending order, and printing the loaded bitmap data.

12. A copy method of performing a copy operation in a copy apparatus using a flat bed scanning mode having a script plate, the method comprising:
scanning a subject disposed on the script plate to be copied and reading out image data therefrom when a copy command is inputted;
determining whether the read image data has a same direction as preset reference image data;
converting the read image data into bitmap data; and
upon determining that the read image data has the same direction as preset reference image data, storing the converted bitmap data in a memory location from a last memory address of a memory location that is assigned for the subject to be copied in a descending order when the image data read out has the direction reverse to the preset reference image data.

13. The copy method of claim 12, further comprising:
sequentially loading the stored bitmap data from a first memory address of the memory location, and printing the loaded bitmap data.

14. A copy method of performing a copy operation in a copy apparatus using a flat bed scanning mode having a script plate, the method comprising:
scanning a subject disposed on the script plate to be copied, and reading out image data therefrom when a copy command is inputted;
determining whether the read image data has a same direction as preset reference image data;
converting the image data read out into bitmap data; and
upon determining that the read image data has a same direction as preset reference image data, storing the converted bitmap data in a memory location that is assigned for the subject to be copied when the read image data has a direction reverse to the present reference image data, loading the stored bitmap data from a last memory address of the memory location in a descending order, and printing the loaded bitmap data.

15. The copy method of claim 14, wherein the printing operation comprises:
sequentially storing the converted bitmap data beginning from a first memory address of the memory location when the result of the determination indicates that the image data read out has the direction reverse to the preset reference image data; and
loading the stored bitmap data from a last memory address of the memory location in the descending order, and printing the loaded bitmap data.

16. A copy apparatus to scan a subject, comprising:
a scanning unit to scan a subject to be copied, and to convert the scanned subject into data; and
a control unit to control the data so that a printed image corresponding to the data is rotated by a predetermined angle with respect to a reference direction.

17. The copy apparatus of claim 16, wherein the predetermined angle is a 180°.

18. The copy apparatus of claim 16, wherein the data is bitmap data.

19. The copy apparatus of claim 16, wherein the copy apparatus comprises a script plate, and the subject is placed on the script plate that the scanning unit scans the subject on the script plate.

20. The copy apparatus of claim 16, wherein the copy apparatus comprises a flat bed scanning mode, and the subject is placed in a stationary state in the flat bed scanning mode.

21. The copy apparatus of claim 16, wherein the subject is in a stationary state, and the scanning unit moves with respect to the stationary subject.

22. The copy apparatus of claim 16, wherein the controller adjusts the data and outputs the adjusted data to print the printed image rotated with respect to the reference direction.

23. The copy apparatus of claim 16, wherein the subject comprises first and second pages, the data comprises first and second sub-data corresponding to the first and second pages, the printed image comprises first and second sub-printed images corresponding to the first and second sub-data, and the controller controls one of the first and second sub-data to print al least one of the first and second sub-printed images to have the angle with respect to the other one of the first and second sub-printed-images.

24. The copy apparatus of claim 23, wherein the first page is one of even and odd numbered pages, and the second page is the other one of the even and odd numbered pages.

25. The copy apparatus of claim 23, wherein the even and odd numbered pages form the angle.

26. The copy apparatus of claim 23, wherein the even and odd numbered pages are in a reverse relationship.

27. The copy apparatus of claim 23, further comprising:
a memory to store the first and second sub-data,
wherein the controller controls the memory to store the first and second sub-data in different storing orders.

28. The copy apparatus of claim 16, further comprising:
a memory to store the data,
wherein the controller controls the memory to store in one of different storing orders.

29. A copy apparatus to scan a subject to be copied, comprising:
a scanning unit to scan first and second pages of the subject to be copied, and to convert the scanned first and second pages of the subject into first and second data; and
a control unit to control one of the first and second data to have an angle between images corresponding to the first and second data.

30. A copy method of scanning a subject, the method comprising:
scanning the subject to be copied;
converting the scanned subject into data; and
controlling the data so that a printed image corresponding to the data is rotated by a predetermined angle with respect to a reference direction.

31. The copy method of claim 30, wherein the predetermined angle is a 180.

32. The copy method of claim 31, wherein the converting of the scanned subject into the data comprises:
converting of the scanned subject into bitmap data.

33. The copy method of claim 30, further comprising:
moving the scanning unit with respect to the subject which is in a stationary state.

34. The copy method of claim 30, wherein the controlling of the data comprises adjusting the data so that the printed image is rotated with respect to the reference direction.

35. The copy apparatus of claim 30, wherein the subject comprises first and second pages, the data comprises first and second sub-data corresponding to the first and second pages, the printed image comprises first and second sub-printed images corresponding to the first and second sub-data, and the controlling of the data comprises controlling one of the first and second sub-data to print at least one of the first and second sub-printed images to have the angle with respect to the other one of the first and second sub-printed-images.

36. The copy apparatus of claim 35, wherein the controlling of the data comprises:
printing first and second sub-printed images to be in a reverse relationship.

37. The copy apparatus of claim 23, wherein the controlling of the data comprises
storing the first and second sub-data in a first storing order and a second storing order, respectively.
